(19) United States
(12) Patent Application Publication
(10) Pub. No.: US 2001/0018668 A1
(43) Pub. Date: Aug. 30, 2001

(54) Method for providing advertising information and a system for evaluating the effectiveness of the advertising

(75) Inventors: Kazuhiro Yanase, Tokyo (JP); Hideki Amemiya, Tokyo (JP); Mamoru Furuya, Tokyo (JP); Makoto Maekawa, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/792,151

(22) Filed: Feb. 23, 2001

(30) Foreign Application Priority Data
Feb. 24, 2000 (JP) 2000-047922

(51) Int. Cl. G06F 17/60

(52) U.S. Cl. 705/14; 705/10

(57) ABSTRACT

The method of providing advertising information comprising a broadcast server and a terminal device connected to this broadcast server, comprises the steps of: broadcasting via the broadcast server advertising information that includes information about at least one of the time, place, and preferences along with the program information; and filtering the advertising information broadcast by the broadcast business according to conditions that include information about at least one of the time, place, and preference, and presents only suitable advertising information that the viewer desires via the terminal device.

### BACKGROUND OF THE INVENTION

1. Field of the Invention

The present invention relates to a method of providing advertising information that can automatically select the broadcast advertising content using information such as the time, place, preferences and the like, and evaluate the effectiveness of the advertising on the audience, and a method and system of evaluating the effectiveness of the advertising.

2. Description of the Related Art

Conventionally, in order to evaluate the effectiveness of advertising, companies carry out audience opinion surveys, and assess the effectiveness of the advertising from the opinion survey about this advertising and the change in sales of the product. In addition, advertising having identical content is broadcast within its broadcast area.

According to conventional methods of providing advertising information and methods of evaluating the effectiveness of the advertising, because it is unclear whether or not the subjects of an audience opinion surveys (or, an audience rating) such as a questionnaire have purchased a product because of viewing advertising, the degree of the effect on increased sales due to the advertising was not exact. In addition, in the same broadcast region, unsuitable advertising may be broadcast because everyone irrespective of location hears the same advertising content, and thus the advertising reach into the audience was not high.

In this manner, seen from the point of view of the advertiser, the degree of the advertising's contribution to sales is unclear, and in relation to advertising information, even if the advertiser wishes to present its product or service only to consumers who may make purchases thereof, the reality of the situation is that the advertising information is broadcast to many and unspecified persons. From the point of view of the consumer, the consumer would wish to receive only advertising that relates to products of interest.

### SUMMARY OF THE INVENTION

In consideration of the above-described problems, it is an object of the present invention to provide a method of providing advertising information and a system for providing the same that allows a viewer (or, a listener) to view only advertising of interest and increase the effectiveness of the advertising by filtering the advertising information that is broadcast by broadcasters according to conditions that include information related to at least one of the broadcast time, the broadcast area, and the preferences of the audience, and the viewer viewing via a terminal apparatus only appropriate advertising information desired by the viewer.

In addition, an object of the present invention is to provide a method and system of evaluating the effectiveness of advertising that stores on an external memory medium in the terminal apparatus the advertising to be the viewed, and can settle accounts of the advertised products or services by bringing this external medium to a store, and reading this external medium using a terminal device located in the store, and at the same time, can make known the effectiveness of the advertising and simplify the analysis of increased sales due to the advertising by carrying out an advertising survey by sending the information that was read to the broadcast business via a communication line.

In order to resolve the above-described problem, in a system for providing advertising information comprising a broadcast server and a terminal device connected to this broadcast server, a first aspect of the method of presenting advertising information broadcasts via this broadcast server advertising information that includes information about at least one of the time, place, and preferences along with the program information, filters this advertising information broadcast by the broadcaster business according to conditions that include information about at least one of the time, place, and preference, and presents only suitable advertising information that the viewer desires via the terminal device.

Thereby, because content of the advertising can be filtered and played according to the conditions of the time, place, and preferences that the consumer desires, presenting only advertising suitable to a consumer becomes possible and the effectiveness of the advertising can be increased.

A second aspect of the method of presenting advertising information in the method according to the first aspect of the invention stores the advertising that is viewed on an external memory medium in the terminal apparatus, and settles accounts of the advertised product or service by bringing this external medium to a store, and reading this external medium using a terminal device located in the store. Thereby, when the accounts of the product or service are settled, whether or not the consumer had viewed the advertising can be verified, and the effectiveness of the advertising can be clarified for the advertiser.

A third aspect of the method of presenting advertising information in the method according to the second aspect of the invention can confirm that the advertising information recorded on the external medium is advertising for a product that is handled at this store, and can reflect this in the settlement of accounts for this product or service. Thereby, discounts of the price of the product or service can be implemented, and the played data can be fed back to the broadcast business via a communication line such as the Internet.

A fourth aspect of the method of providing advertising information in the method according to the second and third aspects of the invention, this external medium includes electronic cash information. Thereby, electronic settlement of accounts becomes possible.

A method of evaluating the effectiveness of advertising in a system for providing advertising information comprising in a fifth aspect of the invention comprises a broadcast server and a terminal device connected to this broadcast server that broadcasts via this broadcast server advertising information that includes information about at least one of the time, place, and preferences along with the program information, filters this advertising information broadcast by the broadcaster business according to conditions that include information about at least one of the time, place, and preference, presents only suitable advertising information that the audience desires via the terminal device, stores on an external memory medium in the terminal apparatus the advertising that is viewed, and settles accounts of the advertised product or service by the consumer bringing this external medium to a store, and reading this external medium using a terminal device located in the store, and at the same time, carries out an advertising survey by sending the information that was read to the broadcast business via a communication line, and thereby makes known the effectiveness of the advertisement.

Thereby, when the accounts are settled for product or service, the broadcast business and the advertiser can verify whether or not the consumer viewed the advertisement, and thus clarify the effectiveness of the advertisement becomes possible.

In a sixth aspect of the invention, the method of evaluating the effectiveness of advertising in the fifth aspect determines the advertising rates according to the product sales and earnings depending on the advertising survey, and thus accounts can be settled. Thereby, the broadcast business can evaluate the characteristics of the audience of programs that include the advertisement, and thus determination of advertising rates according to the sales and earnings of products due to viewing the advertising and the settlement of accounts become possible.

The system of presenting advertising information according to a seventh aspect of the invention comprises a broadcast server that broadcasts advertising information that includes information about at least one of the time, place, and preference in addition to the program information, and a terminal device that is connected to this broadcast server via a broadcast network, filters the advertising information broadcast via the broadcast server by the broadcast business according to conditions that include information about at least one of the place, time, and preference, and presents only suitable advertising information that an viewer desires.

Due to the above structure, the consumer will receive only advertising of interest from among the advertising information broadcast by a broadcast server via the terminal device, and thereby the reach to the consumer of the advertisement can be increased.

The system for evaluating the effectiveness of advertising according to an eighth aspect of the invention comprises a broadcasting server that broadcasts advertising information that includes information about at least one of the broadcast time, broadcast area, and the preferences of the audience; a terminal device that is connected to the broadcast server via a broadcast network, filters the advertising information broadcast via the broadcast server by the broadcast business according to conditions that include information about at least one of the broadcast time, broadcast area, and preferences of the viewer, and presents only suitable advertising information that the viewer desires; and a verification server that stores advertising information that is viewed on an external recording medium in the terminal device, and carries out the settlement of accounts for product or service that has been advertised and the like by the consumer bringing this external medium to a store, and reading this external recording medium via the terminal apparatus in the store, and informs the broadcast business about the effectiveness of the advertising by sending to the broadcast business via a communication line the information that has been read and carries out an advertising survey.

Due to this structure, the advertising play data is stored on an external medium such as a memory card, and the consumer can go to the store when there has been a product or service the consumer wishes to purchase in the advertisement. In addition, when the accounts for the advertised product or service are settled, this external recording medium is read by the terminal in the store, the settlement of accounts is carried out if products or services were purchased at the store, and in addition, by sending this advertising play data to the broadcast business, information related to the effectiveness of the advertising can be obtained at any time without carrying out a survey such as a questionnaire.

In the system for providing advertising information comprising the communication line server and the terminal device connected to the communication line server, the method of providing advertising information according to a ninth aspect of the invention provides information via a communication line related to advertising information including information about at least one of the time, place, and preferences in addition to the broadcast information, filters this advertising information that is information provided by the communication business according to conditions that include information about at least one of the time, place, and preferences, and presents only suitable advertising information that is desired by the viewer via the terminal device.

Thereby, only suitable advertising is presented to the consumer and the effectiveness of the advertising can be increased because the content of the advertising is filtered according to conditions of the time, place, and preferences that the consumer desires, and then the content thereof played.

In the tenth aspect of the present invention, the method for providing advertising information according to the ninth aspect stores the advertising information to be presented on an external recording medium in the terminal device, and can carry out the settlement of accounts for the advertised service or product by the consumer bringing this external medium to the store, and reading this external medium via a terminal device in the store. Thereby, during the settlement of accounts for the product or service, whether or not the consumer viewed the advertisement can be verified, and the effectiveness of the advertisement is clarified for the advertiser.

In the invention according to the eleventh aspect, the method for providing advertising information in the tenth aspect verifies that the advertising information recorded on the external recording medium is advertising for a product that this store handles, and this is reflected in the settlement of accounts for this product or service. Thereby, discounts of the price of the product or service, for example, can be implemented, and the play data fed back to the communication line business via a communication line such as the Internet. This communication line business determines advertising rates according to the sales and earnings of products depending on the advertising survey, and carries out the settlement of accounts. Thereby, discounts of the price of the product or service, for example, can be implemented, and the play data fed back to the communication line business via a communication line such as the Internet.

In a twelfth aspect of the invention, in the method of presenting advertising information according to tenth and eleventh aspects, the external recording medium includes electronic cash information. Thereby, electronic settlement of accounts becomes possible.

The method of assessing the effectiveness of advertising according to a thirteenth aspect in an system for presenting advertising information comprisies a communication line server and a terminal device connected to this communication line server that presents information via the communication line server related to advertising information that includes information about at least one of the time, place, and the preferences in addition to program information, filters this advertising information that is provided by the communication line business according to conditions that include at information about at least one of the time, place, and preferences, presents via the terminal device only suitable advertising information that the audience desires, stores the advertising information to be viewed in an external medium in the terminal device, and carries out settlement of accounts for advertised product or service by bringing this external recording medium to a store, and reading this external recording medium via the terminal device that is located in the store, and at the same time, makes known the effectiveness of the advertising by sending the read information to the communication line business via a communication line, and carries out an advertising survey.

Thereby, during the settlement of accounts for the product or service, the communication line business and the advertisers can verify whether or not the consumer has viewed the advertisement and can clarify the effectiveness of the advertisement.

According to a fourteenth aspect of the method of assessing the effectiveness of advertising, the communication line business in the thirteenths aspect determines the advertising rates according to the sales and earnings of the products depending on the advertising survey, and carries out settlement of accounts.

The system for providing advertising information according to a fifteenth aspect comprises a communication line server that provides advertising information that includes information about at least one of the time, place, preferences along with program information, and a terminal device that is connected via a broadcast network to this communication line server, filters the advertising information that is presented via this communication line server by the communication line business according to conditions that include information about at least one of the time, place, and preferences, and presents only suitable advertising information that the viewer desires. Due to this structure, the consumer may view only advertising of interest via the advertising information distributed by the communication line server, and thereby the advertising reach to the consumer can be increased.

A system for assessing the effectiveness of the sixteenth aspect comprises a communication line server that provides advertising information that includes information about at least one of the time, place, preferences along with program information; a terminal device that is connected via a broadcast network to this communication line server, filters the advertising information that is presented via this communication line server by the communication line business according to conditions that include information about at least one of the time, place, and preferences, and presents only suitable advertising information that the viewer desires; and a verification server that stores advertising information to be viewed on an external recording medium in the terminal device, and carries out the settlement of accounts for a product or service that has been advertised and the like by the consumer bringing this external medium to a store, and reading this external recording medium via the terminal apparatus in the store, and informs the broadcast business about the effectiveness of the advertising by sending to the broadcast business via a communication line the information that has been read and carries out an advertising survey.

Thereby, the advertising play data is stored on an external medium such as a memory card, and the consumer can go to the store when there has been a product or service the consumer wishes to purchase in the advertisement. In addition, when the accounts for the advertised product or service are settled, this external recording medium is read by the terminal in the store, the settlement of accounts is carried out if products or services were purchased at the store, and in addition, by sending this advertising play data to the broadcast business, information related to the effectiveness of the advertising can be obtained at any time without carrying out a survey such as a questionnaire.

### BRIEF DESCRIPTION OF THE DRAWINGS

FIG. 1 is a drawing of an embodiment of the present invention showing conceptually the flow of products/information and money.

FIG. 2 is a block drawing showing the internal structure of the server computer possessed by the broadcast business shown in FIG. 1.

FIG. 3 is a block diagram showing the internal structure of the consumer terminal possessed by the consumer shown in FIG. 1.

FIG. 4 is a block diagram showing the internal structure of the store terminal possessed by the advertiser shown in FIG. 1.

FIG. 5 is a flowchart shown in order to explain the operation of the embodiment shown in FIG. 1.

FIG. 6A is a drawing showing the format 1 of the data that transmits each block in the embodiment of the present invention shown in FIG. 1.

FIG. 6B is a drawing showing the format 2 of the data that transmits each block in the embodiment of the present invention shown in FIG. 1.

FIG. 6C is a drawing showing the format 3 of the data that transmits each block in the embodiment of the present invention shown in FIG. 1.

FIG. 7 is a drawing of an embodiment of the present invention showing conceptually the flow of products/information and money.

FIG. 8 is a flowchart shown in order to explain the operation of the embodiment shown in FIG. 7.

FIG. 9 is a drawing of another embodiment of the present invention for conceptually showing the flow of products/information and money.

FIG. 10 is a flowchart shown in order to explain the operation of the embodiment shown in FIG. 7.

FIG. 11A is a drawing showing the format 1 of the data that transmits each block in the embodiment of the present invention shown in FIG. 1.

FIG. 11B is a drawing showing the format 2 of the data that transmits each block in the embodiment of the present invention shown in FIG. 1.

FIG. 11C is a drawing showing the format 3 of the data that transmits each block in the embodiment of the present invention shown in FIG. 1.

FIG. 11D is a drawing showing the format 4 of the data that transmits each block in the embodiment of the present invention shown in FIG. 1.

### PREFERRED EMBODIMENTS OF THE INVENTION

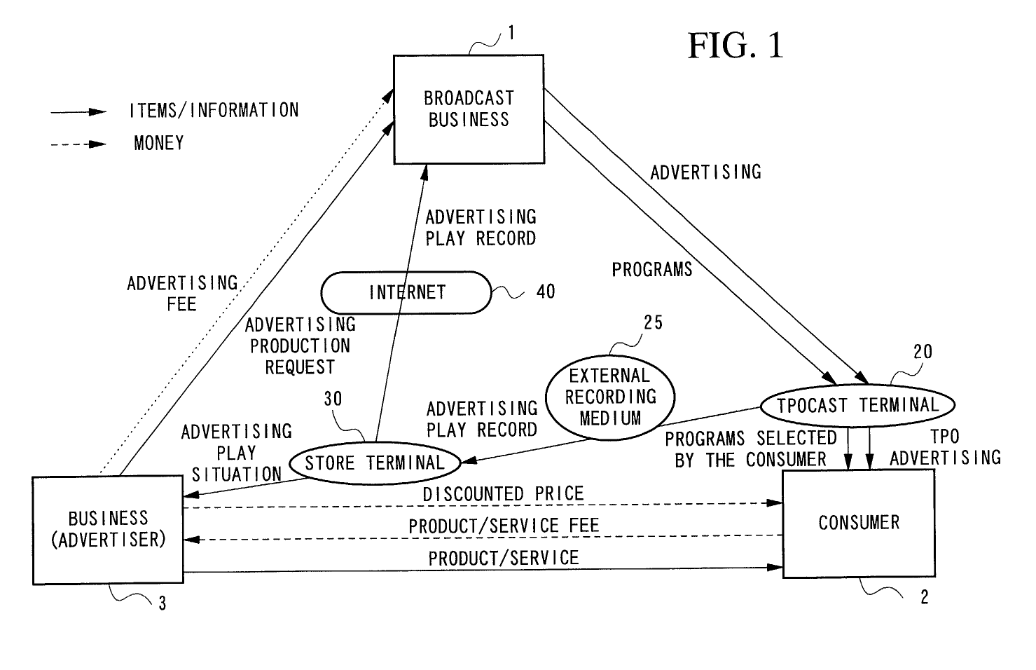

FIG. 1 is the basic model showing conceptually the method of presenting advertising information and the method of assessing the effectiveness of advertising according to an embodiment of the present invention. Here, the flow of products and information between the broadcast business 1, the consumer 2 that views the broadcast by the broadcast business, and the business (advertiser) 3 that sells the product or service to the consumer 2 are shown by the arrows of the solid lines, and the flow of money is shown by the broken lines.

In FIG. 1, the consumer 2 possesses a terminal device 20 for viewing broadcasts from the broadcast business 1. This terminal device 20, as described below, is hereinbelow called a TPOCast terminal 20 because the advertising information to be broadcast is viewed after being filtered in line with information about the time (T), place (P), and preferences (0) that are desired by the user. In addition, a store terminal 30 is located at the store of the business 3. The external recording medium 25 records the advertising play record of the TPOCast terminal 20, and allows verification of the advertising summary of the business 3 using the store terminal 30.

In the above-described structure, the broadcast business 1 produces programs and the advertisements requested by the business 3. In the advertising, for example, the broadcast time, broadcast area, and preference information is included, and the broadcast business 1 broadcasts this advertising and programs. The TPOCast terminal 20 receives the broadcasts produced and output by the broadcast business 1. Among the broadcasts that are received, the advertising data is filtered by each of the above conditions of time, place, and preferences, and only suitable advertising is played to the consumer. At this time, data about the advertising that was played is recorded on the external recording medium (memory card 25) in the TPOCast terminal 20.

The consumer 2 views the programs and advertising played on the TPOCast terminal 20. In addition, in the case there are products or services that the consumer wishes to purchase in the viewed advertising, he or she goes to the store of the business 3 that sells this product or service. At the store of the business 3, the product or service is sold to the consumer 2. In the case that the consumer 2 has viewed the broadcast advertisement and gone to purchase the product or service, the external recording medium 25 of the TPOCast terminal 20 possessed by the consumer 2 is read by the store terminal 30 in this store, and whether or not the advertising of the product or service that is sold has been played is verified. In the case that the advertising has been played, a discount of the price of the product or service can be implemented, and the played data sent to the broadcast business 1 via the Internet 40.

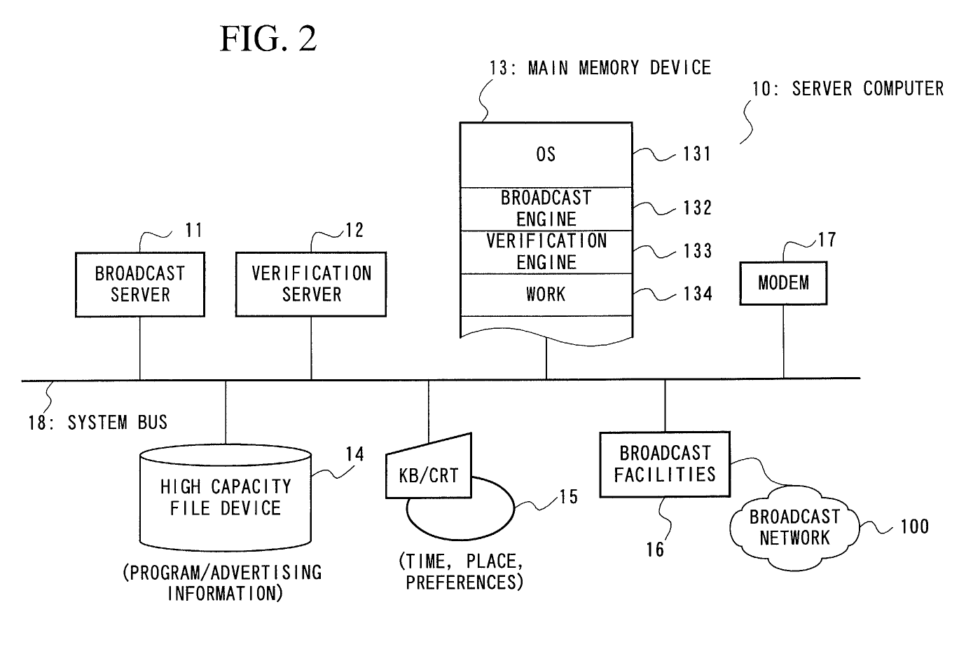

FIG. 2 through FIG. 4 are drawings showing the internal structure of the server computer 10 possessed by the broadcasting business 1, the TPOCast terminal 20 possessed by the consumer 2, and the store terminal 30 possessed by the business 3 in the store, all of which are as shown in FIG. 1.

In FIG. 2, the server computer 10 is formed by a broadcast server 11, a verification server 12, a main memory device 13, a high capacity file device 14, a keyboard and display device 15, broadcast facilities 16, and a modem 17. The broadcast server 11 sends to many and unspecified consumers the programs and advertising information produced by the broadcast engine 132 allocated in the main memory device 13 via the broadcast facilities 16 and the broadcast network 100. The verification server 12 carries out verification of the information that is fed back via the store terminal 30 according to the verification engine 133 allocated in the main memory device 13.

The OS 131 also resides in the main memory device 13, and each of the above-described engines 132 and 133 carry out program processing for broadcasts and verification by using the work 134 in cooperation with the OS 131.

The high capacity file device 14 stores programs produced by the broadcast engine 132, advertising information, play information that is fed back from the store terminal 30, and depending on necessity, reads the main memory device 13. The keyboard and display device 15 is the part that provides the man-machine interface, displays necessary information, and in relation to the present invention, keys-in information such as time, place, and preferences when producing advertising information. Reference numeral 17 is a modem, and via this modem 17, the store terminal 30 is connected to other store terminals. The above-described broadcast server 11, verification server 12, main memory device 13, large capacity file device 14, keyboard and display 15, and broadcast facilities 16 are connected to each other via the system bus 18.

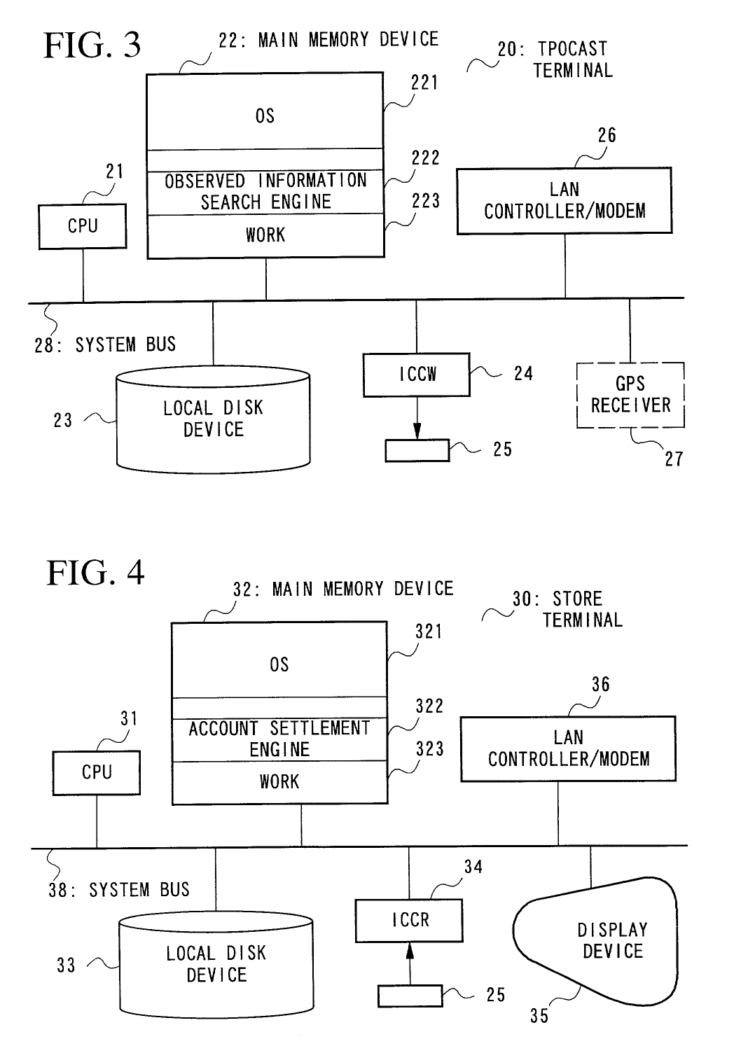

In FIG. 3, the TPOCast terminal 20 comprises a CPU 21, which is the central control, a main memory device 22, a local disk device 23, a card writer (ICCW) 24, an external memory medium 25 such as a memory card, and a LAN controller (modem) 26. Furthermore, the GPS receiver 27 can be installed as an option.

The survey information search engine 222 allocated in the main memory device 22 is a search engine for filtering the advertising information broadcast by the broadcasting business 1 according to conditions related to TPO such as the broadcast time, broadcast area, and the preferences of the audience, and presenting only suitable advertising information that the consumer desires. The CPU 21 downloads to the local disk device 23 according to the survey information search engine 222, and carries out a search of program information that includes accumulated advertising information. The OS 221 also resides in the main memory device 22, and the survey information search engine 222 carries out program processing for searches by using the work 223 in cooperation with the OS 221.

The card writer 24 writes data generated by the CPU 21 in the external recording medium 25 such as an installed memory card, and here, information that is found and has been played by the consumer is written on the external memory medium 25. The LAN controller (modem) 26 is a communication control device necessary for connecting to the Internet, and in addition, the GPS receiver 27 is installed in order to inform broadcast business 1 about the broadcast area. Moreover, the above-described CPU 21, main memory device 22, local disk device 23, card writer 24, LAN controller (modem) 26, and the GPS receiver 27 are connected together via the system bus 28.

In FIG. 4, the store terminal 30 comprises a CPU 31 that is the central control, the main memory device 32, the local disk device 33, the card reader (ICCR) 34, the display device 35, and the LAN controller (modem) 36. The account settlement engine 322 allocated in the main memory device 32 stores advertising information that has been viewed using the TPOCast terminal 20 in the memory card 25, the memory card 25, serving as the external recording medium, is brought to the store, the memory card 25 is read via a card reader 34 built into the store terminal 30, and the settlement of accounts for the advertised product or service is carried out.

The OS 321 also resides in the main memory device 32, and account settlement engine 322 carries out program processing for the settlement of accounts described below using the work 323 in cooperation with the OS 321. Moreover, the LAN controller (modem) 36 is a communication control device necessary for connecting to the Internet, and the CPU 31, the main memory device 32, the local disk device 33, the card reader 34, and the display device 35 are connected together via the system bus 38.

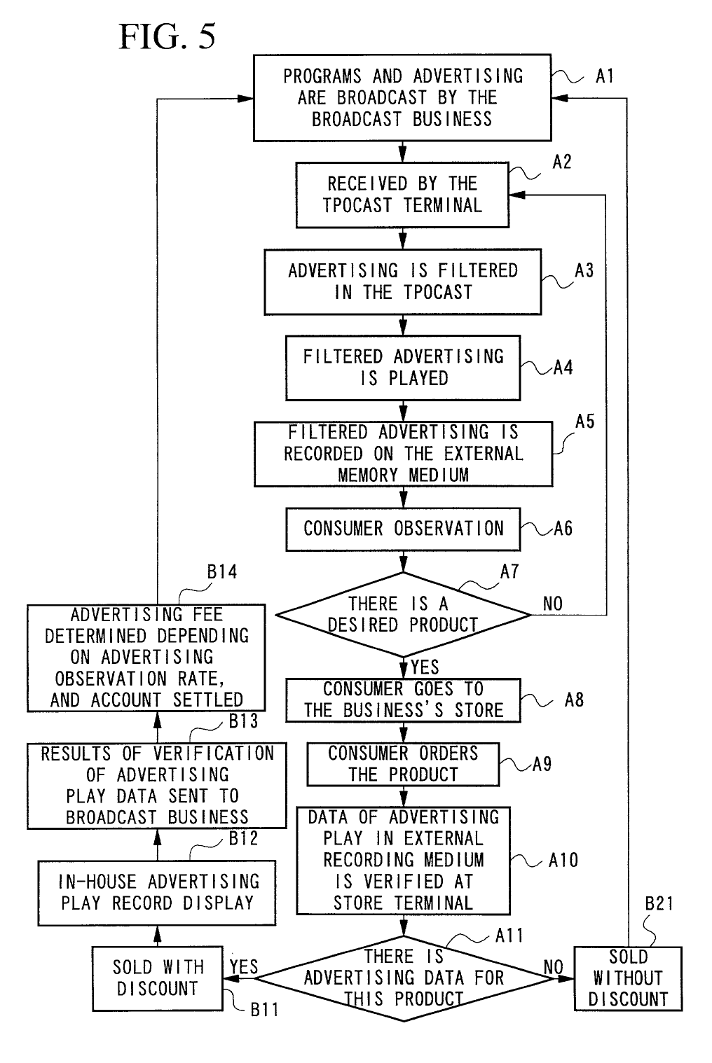

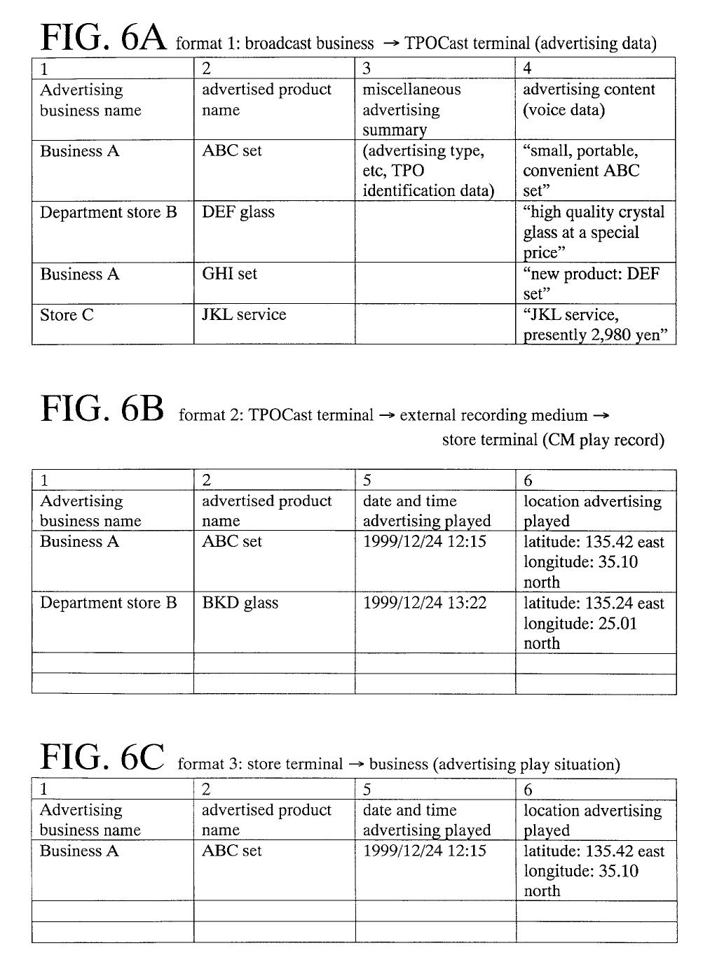

Next, referring to the flowchart shown in FIG. 5 and the data formats shown in FIGS. 6A, 6B, and 6C, the operation of the embodiment of the present invention shown in FIG. 1 through FIG. 4 will be explained in detail.

First, the broadcast business 1 outputs advertising requested and produced by the advertiser 3 of the business along with the programs, and broadcasts them via the broadcast network 100 (step A1). At this time, the format of the advertising data that is broadcast is shown as format 1 in FIG. 6A. This advertising data comprises the name of the advertising business, the name of the advertised product, in addition to a summary of the advertising, and the contents of the advertising.

Here, the advertising content is data necessary for categorizing the TPO conditions, for example, the advertising classification of the product name and the service name, etc., the business classification of the service industry, production industry, etc., the advertising time, and the advertising area. In addition, the advertising content can be voice data that is actually heard by the consumer.

Next, the TPOCast terminal 20 receives the broadcast output from the broadcast business 1 (step A2). In addition, the TPOCast terminal 20 filters the received data so that depending on time, place, and preference information, the most appropriate viewed information for the consumer is obtained (step A3). In this manner, only filtered advertising is played for the consumer 2, and at the same time, this data about the advertising that was played is stored in the external recording medium 25 (step A4, A5, and A6). At this time, the advertising business name, the advertised product name, the date and time the advertising was played, and the location that the advertising was played are recorded as data in the memory card 25 serving as the external memory medium from the TPOCast terminal 20, using the format 2 shown in FIG. 6B. The date and time that the advertising is played denotes the time that the TPOCast terminal 20 was played, and specifically, is measured by a built in timer (not illustrated). In addition, the location that the advertising was played denotes the location that the TPOCast terminal 20 was played, and specifically, is the position information obtained by the GPS receiver 27.

Next, when there is a product that the viewing consumer 2 likes among the played advertising data, the consumer 2 goes to the store of the business 3, and if there is not any of the desired product, continues viewing the received broadcasts of the TPOCast terminal 20 (steps A7, A8). In addition, the consumer 2 orders the produce at the store of the business 3 (step A9). Furthermore, the memory card 25 that the consumer 2 is carrying is inserted into the card reader 34 of the store terminal 30, and whether or not the data recorded in this memory card 25 is advertising for a product that is handled by this store (step A10). As a result of the check, in the case that this is not a corresponding business or product, the product is sold at the displayed price (step A11, B21). When this is a corresponding business or produce, the product is sold at the discounted price (step A11, B11). At the business 3, only the data for the advertising played for this business is displayed on the display device 35 of the store terminal 4 (step B12).

Moreover, after the discounted sale, the advertising play data is also sent to the advertiser (step B13). At this time, the advertising business name, advertised product name, the date and time that the advertising was played, and the location that the advertising was played are sent to the advertiser form the store terminal 30, as shown in format 3 in FIG. 6C. Last, depending on the product sales and earnings depending on the advertising viewing, the advertising fee is determined, and processing to carry out settlement of accounts is executed (step B14). This processing for the settlement of accounts depends on the account settlement engine 322.

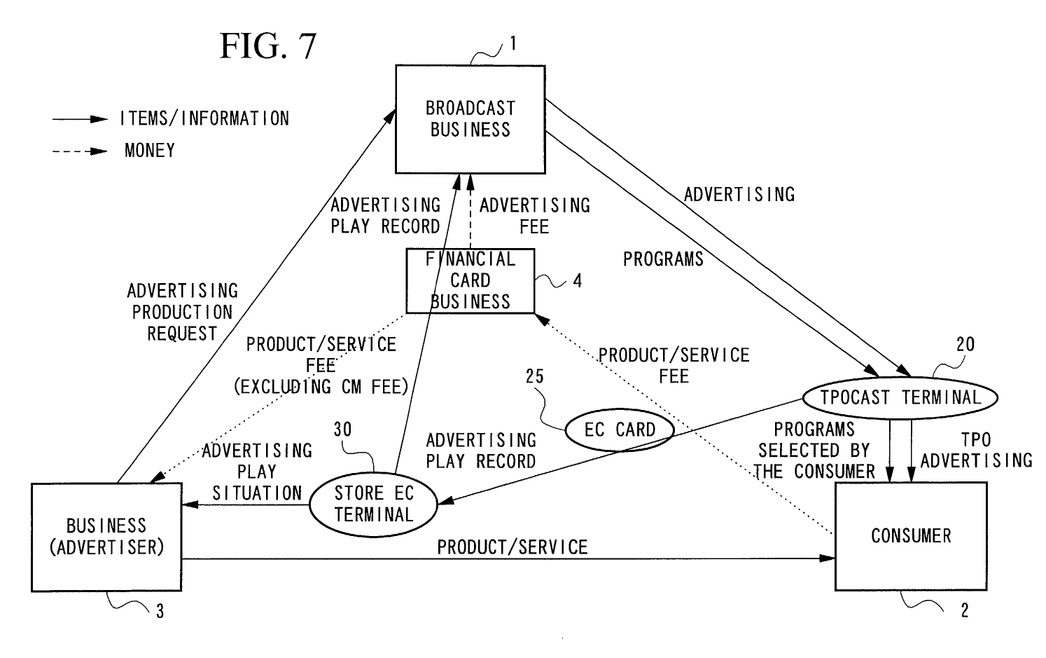

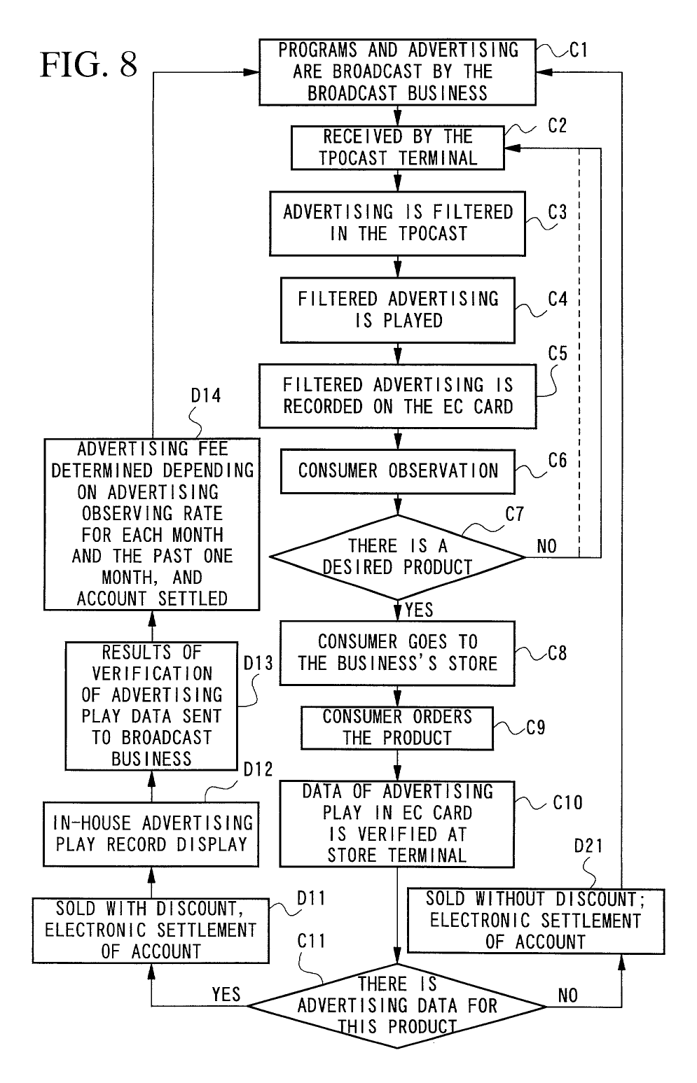

Next, as another embodiment of the present invention, the flow of product, information, and money shown in FIG. 7 will be explained in detail referring to the flowchart in FIG. 8.

This embodiment is formed by the broadcast business 1, the consumer 2 that views the advertising of the broadcast business 1, the business 3 that requests the advertising from the broadcast business 1 and sells a product or service to the consumer 2, and a financial card business 4 that carries out the settlement of accounts between the consumer 2 and the business 3 using an EC (electronic commerce) card, and makes the commercial play record and settles the advertising fees for the broadcast business 1.

The consumer 2 has a TPOCast terminal 20 for viewing the broadcasts of the broadcast business 1. A store terminal 30 is located in the store of the business 3. The EC card 25, which serves as the external recording medium, records the advertising play record information of the TPOCast terminal 20, and can verify the advertising summary of the business 3 at the store terminal 30.

First, the broadcast business 1 outputs and broadcasts advertising and programs requested by the advertiser and produced. At this time, the format of the broadcast advertising data, shows as format 1 in FIG. 6A, comprises the advertising business name, the advertised product name, in addition to advertising summary and advertising content (step C1). Next, the TPOCast terminal 20 receives the broadcast output from the broadcast business 1 (step C2). Next, the TPOCast terminal 20 suitably filters the received data for the consumer 2, depending on the time, place, and preference information (step C3). Then only filtered advertising is played and output to the consumer, and at the same time, the played advertising data is recorded on the EC card 25. At this time, as shown by format 2 in FIG. 6B, the advertising business name, the advertised product name, the date and time the advertising is played, and the location that the advertising is played from the TPOCast terminal 20 are recorded on the EC card 25 (steps C4, C5, and C6).

Next, if there is a product that the consumer likes among the played advertising data that was viewed, this consumer 2 goes to the store of the business 3, and if the desired product is not there, continues to view the received broadcast of the TPOCast terminal 20 (steps C7, C8). In addition, the consumer 2 orders the product at the store of the business 3 (step A9). In addition, the consumers EC card 25 is inserted into the store terminal 30, and the data recorded on the EC card 25 is checked for whether or not the advertising is for a product that this store handles (step C10). As a result of the check, in the case that there is no corresponding business or product, the settlement of accounts is carried out with the EC card at the displayed price (steps C11, D21). If there is a corresponding business or product, the settlement of accounts is carried out with the EC card at a discounted price (steps C11, D11). At the business 3, only data of the advertising played for that business is displayed on the store terminal 30 (step D12).

Next, after settlement of accounts with the EC card at the discounted price, as shown in format 3 in FIG. 6C, the data of the advertising play is also sent to the advertising business (step D13). Finally, the advertising fee is determined according to the product sales and earnings depending on advertising viewing each month and for the past one month, and the financial card business 4 pays the advertising fee to the broadcast business 1, and the financial card business 4 pays to the business an amount from which the advertising fee from the product settlement amount is deducted (step D14).

Because of being structured in this manner, the advertising fee can be automatically settled depending on the product sales and earnings depending on the advertising viewing each month.

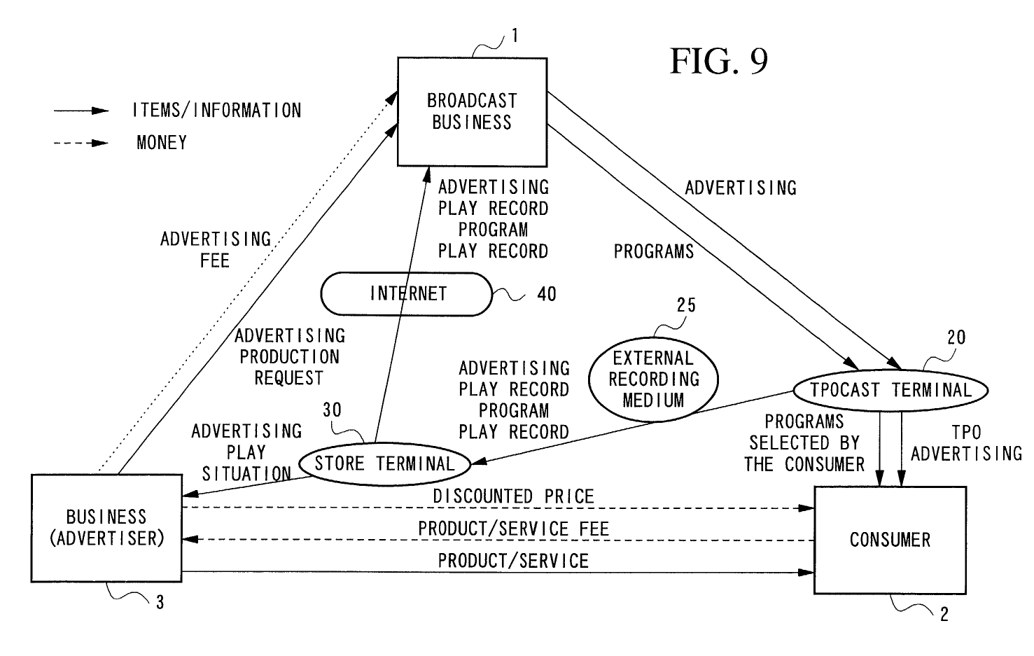

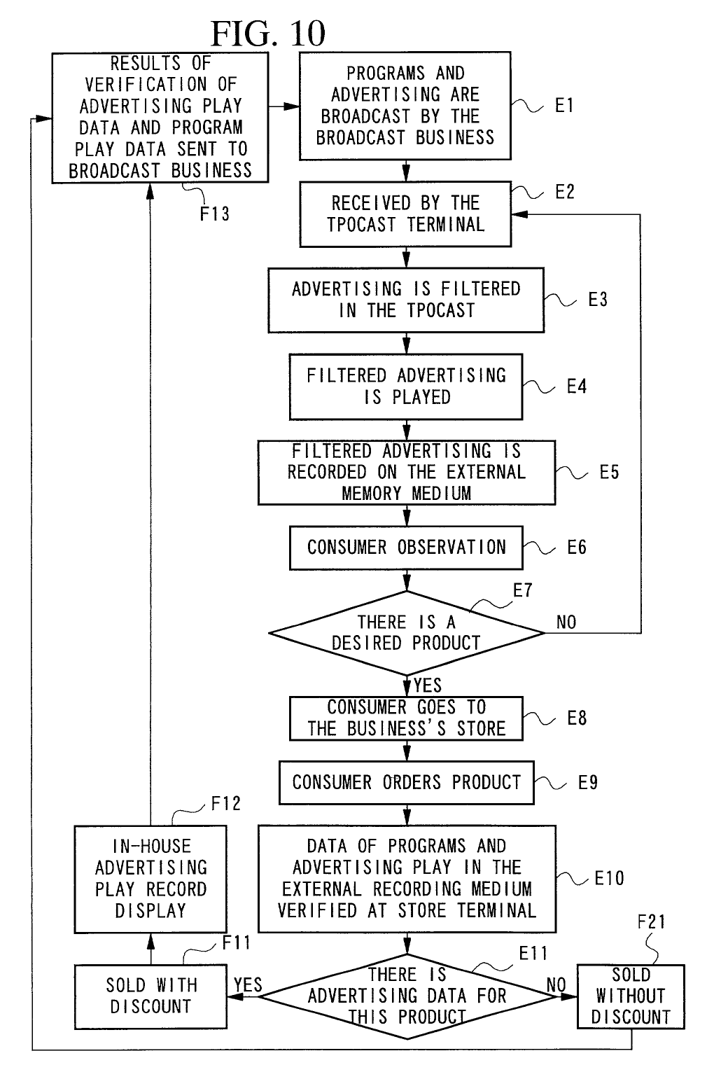

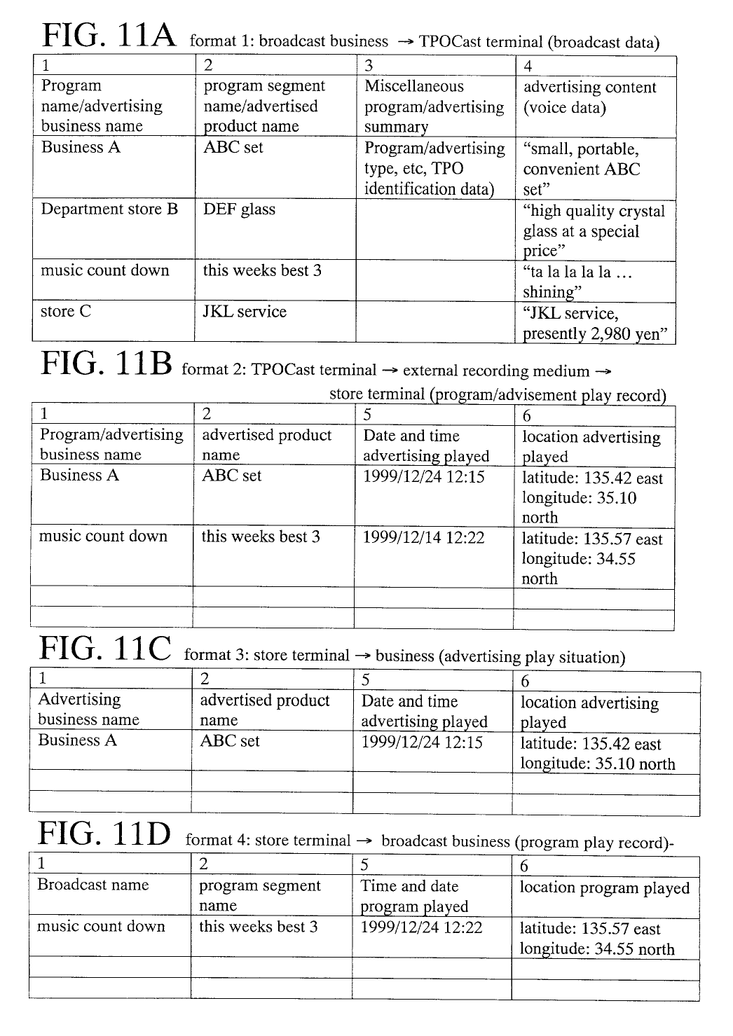

Next, as yet another embodiment of the present invention, the flow of products, information, and money shown in FIG. 9 are explained in detail referring to the flowchart shown in FIG. 10 and the data format shown in FIG. 11.

In FIG. 9, the embodiment comprises a broadcast business 1, a consumer 2 that views the broadcasts of the broadcast business 1, and a business 3 that requests the broadcast business 1 to produce advertising, and sells the product or service to the consumer 2. The consumer 2 possesses a TPOCast terminal 20 for viewing the broadcasts of the broadcast business 1. A store terminal 30 is located in the store of the business. The memory card 25, which serves as the external recording medium, records the program/advertising play record of the TPOCast terminal 20, verifies the advertising summary of the business at the store terminal 30, and sends this program play record to the broadcast business 1.

First, the broadcast business 1 outputs and broadcasts advertising requested from and produced by the advertiser 3 along with programs (step E1). At this time, the format of the broadcast data, shown as format 1 in FIG. 11A, comprises the product name/advertising business name, program segment name, advertised product name, in addition to broadcast/advertising summary, and the program/advertising content. Next, the TPOCast terminal 20 receives the broadcast output by the broadcast business 1 (step E2). In addition, the TPOCast terminal 20 suitably filters the received data for the consumer according to the time, place, and preference information (step E3).

Next, only the programs selected by the consumer and the filtered advertising are played, and at the same time, the programs that are played and advertising data are recorded on the memory card 25 (steps E4, E5, and E6). At this time, as shown in format 2 in FIG. 11B, the program name/advertising business name, the program segment name/advertised product name, the date and time the program and advertising were played, and the location that the program and advertising were played are recorded on the memory card 25 from the TPOCast terminal 20. In addition, when there is a product that the consumer likes viewed in the played advertising data, the consumer goes to the business store, and if the desired product is not there, continues viewing the broadcasts received by the TPOCast terminal 20 (steps E7, E8).

Next, the consumer 2 orders the product (step E9). In addition, the consumer's memory card 25 is inserted into the store terminal 30, and the data recorded on this memory card 25 is checked for whether this is advertising for a product that this store handles (step E10). As a result of this check, in the case there is no corresponding business or product, the sale is made at the displayed price, and the program play data is sent to the broadcast business 1 from the store terminal 30 (steps E1, F21, F13). In the case that there is a corresponding business and product, the sale is made with a discount (steps E11, F11), and only the advertising play data of this business is displayed on the store terminal 30 (step B12).

In addition, as shown in formats 3 and 4 in FIG. 11C and FIG. 11D, after the sale at a discount, the program and advertising play data is also sent to the broadcast business 1 (step F13). Finally, the advertising fee is determined according to the product sales and earnings depending on the advertising viewing, and the accounts are settled (step B14). Due to this type of structure, the broadcast business can assess the program viewing situation.

In the present invention as explained above, the broadcast business 1 carries out programming and advertising having a time (T), place (P), and preferences (O). The consumer 2 receives these broadcasts in a consumer terminal 20, and the consumer terminal 20 plays advertising and programs depending on each of the received time, place, and preference conditions, and thereby the consumer views only suitable advertising. At this time, the advertising play data is stored in the external recording medium 25 such as a memory card mounted in the consumer terminal 20, and in the case that there is a product or service in this advertising that the consumer 2 wishes to purchase, the consumer 2 goes to the store, and at the time the account for the advertised product or service is settled, when the external recording medium 25 such as a memory card is simultaneously displayed, this play data is read from this external recording medium 25 at the store terminal 30 in the store of the business, and if this is a product or service that this store sells, the price is discounted. In addition, the terminal that was read sends the advertising play data to the broadcast business 1. Thereby, the consumer 2 views only suitable advertising, and the effectiveness of the advertising can be obtained at any time without carrying out a survey such as a questionnaire.

Moreover, in the above embodiments, the case was explained wherein the advertising information is distributed by the broadcast business, but this applies similarly to the case wherein the advertising information is distributed from the business via a communication line.

According to the present invention as explained above, advertising information and program information including information about at least one of the time, area and viewer preferences for the provided broadcasts and information are provided via broadcasting and communication lines, the advertising information provided by the broadcast business and the communication line business is played to the consumer by being filtered according to conditions that include information about at least one of the time, area, and consumer preferences, viewing only suitable advertising information that is desired by the viewer, and thereby, only suitable advertising is presented to the consumer.

In addition, the advertising information that was viewed is stored in the external recording medium in the consumer terminal, and this external recording medium is brought to the store and read via a terminal in the store. Thereby, the settlement of accounts for advertised product or service can be carried out, and in addition, the effectiveness of the advertising made known by sending the read information to the broadcast and communication line businesses. Thereby, when accounts for the product or service are settled, whether or not the consumer viewed the advertising can be verified, and the business, the broadcast business, and the communication line business can clarify the effectiveness of the advertising.

Furthermore, the business can clarify the method of determining the advertising fees paid to the broadcast business and the communication line business and because only suitable advertising is viewed, and only strictly selected advertising is presented, the advertising reach to the consumer user can be increased. By compressing data when the advertising data is sent from the broadcast business to the consumer terminal, in the same amount of time, more advertising can be presented that then case of using conventional broadcasting and communication lines, and thus the amount of advertising that is handled can be increased.

What is claimed is:

1. A method of providing advertising information comprising a broadcast server and a terminal device connected to this broadcast server, comprising the steps of:
broadcasting via said broadcast server advertising information that includes information about at least one of the time, place, and preferences along with the program information; and
filtering said advertising information broadcast by the broadcast business according to conditions that include information about at least one of said time, place, and preference, and presents only suitable advertising information that the viewer desires via said terminal device.

2. A method of providing advertising information according to claim 1 comprising the steps of:
storing said advertising information that was viewed on an external recording medium in said terminal device; and
settling accounts of said advertised product or service by the consumer bringing said external medium to a store, and reading said external medium using a terminal device located in the store.

3. A method of providing advertising information according to claim 2 comprising the steps of:
confirming the advertising information recorded on said external medium is advertising for a product that is handled at this store, and
reflecting this in the settlement of accounts for said product or service.

4. A method of providing advertising according to claim 2 wherein said external medium includes electronic cash information.

5. A method of evaluating the effectiveness of advertising in a system for providing advertising information comprising a broadcast server and a terminal device connected to this broadcast server comprising the steps of:
broadcasting via said broadcast server advertising information that includes information about at least one of the time, place, and preferences along with the program information;
filtering said advertising information broadcast by the broadcaster business according to conditions that include information about at least one of said time, place, and preference, presents only suitable advertising information that the audience desires via the terminal device;
storing said advertising information that has been viewed on an external recording medium in said terminal device; and
settling accounts of said advertised product or service by the consumer bringing said external medium to a store, and reading said external medium using a terminal device located in the store, and at the same time, sends the information that was read to said broadcast business via a communication line, carries out an advertising survey, and thereby makes known the effectiveness of the advertisement.

6. A method of evaluating the effectiveness of advertising according to claim 5 comprising the steps of:
determining by said broadcast business the advertising rates according to the product sales and earnings depending on the advertising survey; and
carrying out the settlement of accounts.

7. A system of presenting advertising information comprising:
a broadcast server that broadcasts advertising information that includes information about at least one of the time, place, and preference in addition to the program information; and
a terminal device that is connected to said broadcast server via a broadcast network, filters the advertising information broadcast via said broadcast server by the broadcast business according to conditions that include information about at least one of the said place, time, and preference, and presents only suitable advertising information that an viewer desires.

8. A system for evaluating the effectiveness of advertising comprising:
a broadcasting server that broadcasts advertising information that includes in formation about at least one of the broadcast time, broadcast area, and the preferences of the viewer;
a terminal device that is connected to said broadcast server via a broadcast network, filters the advertising information broadcast via the broadcast server by the broadcast business according to conditions that include information about at least one of said time, place, and preferences, and presents only suitable advertising information that the viewer desires; and
a verification server that stores said advertising information that has been viewed on the external recording medium in said terminal device, carries out the settlement of accounts for said product or service that have been advertised by bringing said external medium to a store, and reading said external recording medium via the terminal apparatus in the store, and in addition, makes known the effectiveness of the advertising by sending said information that was read to said broadcast business via a communication line.

9. A method of providing advertising information in a system for presenting advertising information comprising a communication line server and a terminal device connected to said communication line comprising the steps of:
providing information via a communication line related to advertising information including information about at least one of said time, place, and preferences in addition to the broadcast information; and
filtering this advertising information that is information provided by the communication business according to conditions that include information about at least one of the time, place, and preferences, and presents only suitable advertising information that is desired by the viewer via said terminal device.

10. A method for providing advertising information according to claim 9 comprising the steps of:
storing advertising information that has been viewed on an external recording medium in said terminal device; and
carrying out the settlement of accounts for said advertised services and products by bringing said external medium to the store, and reading said external medium via a terminal device located in the store.

11. A method for providing advertising information comprising the steps of:
verifying that the advertising information recorded on said external recording medium is advertising for a product that this store handles; and
reflecting this in the settlement of accounts for said product or service.

12. A method of presenting advertising information according to claim 10, wherein said external recording medium includes electronic cash information.

13. A method of assessing the effectiveness of advertising in an system for presenting advertising information comprising a communication line server and a terminal device connected to this communication line server comprising the steps of:
presenting information via said communication line server related to advertising information that includes information about at least one of the time, place, and the preferences in addition to program information,
filtering this advertising information that is provided by the communication line business according to conditions that include at information about at least one of the said time, place, and preferences, presents via said terminal device only suitable advertising information that the audience desires;
storing said advertising information that has been viewed on an external recording medium in said terminal device; and
storing the advertising information to be viewed in an external medium in the terminal device, and carries out settlement of accounts for said advertised product or service by bringing said external recording medium to a store, and reading said external recording medium via the terminal device that is located in the store, and at the same time, makes known the effectiveness of the advertising by sending said information that was read to said communication line business via a communication line, and carries out an advertising survey.

14. A method of assessing the effectiveness of advertising according to claim 5 comprising the steps of:
determining by the communication line business the advertising rates according to the sales and earnings of the products depending on the advertising survey; and
carrying out settlement of accounts.

15. A system for providing advertising information comprising:
a communication line server that provides advertising information that includes information about at least one of the time, place, preferences along with program information; and
a terminal device that is connected via a broadcast network to said communication line server, filters the said advertising information that is presented via this communication line server by the communication line business according to conditions that include information about at least one of said time, place, and preferences, and presents only suitable advertising information that the audience desires.

16. A system for assessing the effectiveness of advertising comprising:
a communication line server that provides advertising information that includes information about at least one of the time, place, preferences along with program information;
a terminal device that is connected via a broadcast network to said communication line server, filters said advertising information that is presented via said communication line server by the communication line business according to conditions that include information about at least one of said time, place, and preferences, and presents only suitable advertising information that the audience desires; and
a verification server that stores advertising information to be viewed on an external recording medium in the terminal device, and carries out the settlement of accounts for said product or service that have been advertised, bringing said external medium to a store, and reading said external recording medium via the terminal apparatus in the store, and in addition, makes known the effectiveness of the advertising by sensing said information that was read to said communication line business via a communication line.
